(19) United States
(12) Patent Application Publication
(10) Pub. No.: US 2022/0179940 A1
(43) Pub. Date: Jun. 9, 2022

(54) LOST DATA CARD LOCATOR

(71) Applicant: Wanda Stanford, Zanesville, OH (US)

(72) Inventor: Wanda Stanford, Zanesville, OH (US)

(21) Appl. No.: 17/114,494

(22) Filed: Dec. 8, 2020

(51) Int. Cl. G06F 21/44; G06K 19/07; H04W 4/029

(52) U.S. Cl. CPC G06F 21/44; H04W 4/029; G06K 19/07

(57) ABSTRACT

An illustrated view of an exemplary banking card locator for locating a lost or stolen banking card is presented. The banking card locator is useful tracking and finding lost or stolen credit and/or debit cards, individually referred to as a banking card and collectively referred to as banking cards. The banking card locator aids in reducing stress and aggravation of losing the banking card by alerting a location of the banking card immediately. Further, the banking card locator is useful for preventing unwanted charges and identity theft.

### FIELD OF THE INVENTION

This invention relates to data cards. More particularly, it relates to locating lost data cards.

### BACKGROUND

A data card k generally regarded as a credit card or debit card. A credit card or debit card k a payment card issued to users (cardholders) to enable the cardholder to pay a merchant for goods and services based on the cardholder's promise to the card issuer to pay them for the amounts plus the other agreed charges. The card issuer (usually a bank) creates a revolving account and grants a line of credit to the cardholder, from which the cardholder can borrow money for payment to a merchant or as a cash advance.

A credit card is different from a charge card, which requires the balance to be repaid in full each month. In contrast, credit cards allow the consumers to build a continuing balance of debt, subject to interest being charged. A credit card also differs from a cash card, which can be used like currency by the owner of the card. A credit card differs from a charge card also hi that a credit card typically involves a third-party entity that pays the seller and k reimbursed by the buyer, whereas a charge card simply defers payment by the buyer until a later date.

Often times, people misplace or lose their credit card or debit card. This can be devastating when the card is not available when they wish to use the card to purchase a product. Further, the card holds personal information that can be retrieved from the card and places the financial and personal information of the person at risk. Currently, the only remedy for the loss of a card is to call the credit card company and report the loss. Before notifying the card company and having a block placed on the card, there is a time period where the person's financial and personal information is at risk.

Card holders find nothing more frustrating than not being able to find common personal items that they had in their hands perhaps just minutes before. The items include, but not limited to, cell phones, eyeglasses, remote controls, toys, credit cards, debit cards, etc. Loss of credit and debit cards strike fear in the card holder when the card holder has lost their credit or debit card and have no idea where to find it. Perhaps it has been left at a store, fallen out of a purse or wallet, lost in a car, bus or train, or worse yet, stolen from the holder's purse or pocket. Not only does one have to worry about unwanted charges, but the weeks and months ahead trying to correct the problem of possible identity theft. Worry and loss of time trying to find the banking card can be very frustrating.

Accordingly, and in light of the foregoing, there is a need for a means by which banking cards can be located quickly and easily.

### BRIEF DESCRIPTION OF THE DRAWINGS

FIG. 1A is an illustrated view of an exemplary banking card locator.

FIG. 1B is an illustrated view of a chip for the banking card locator shown in FIG. 1A.

FIG. 2 is an illustrated view of a use of the banking card locator shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

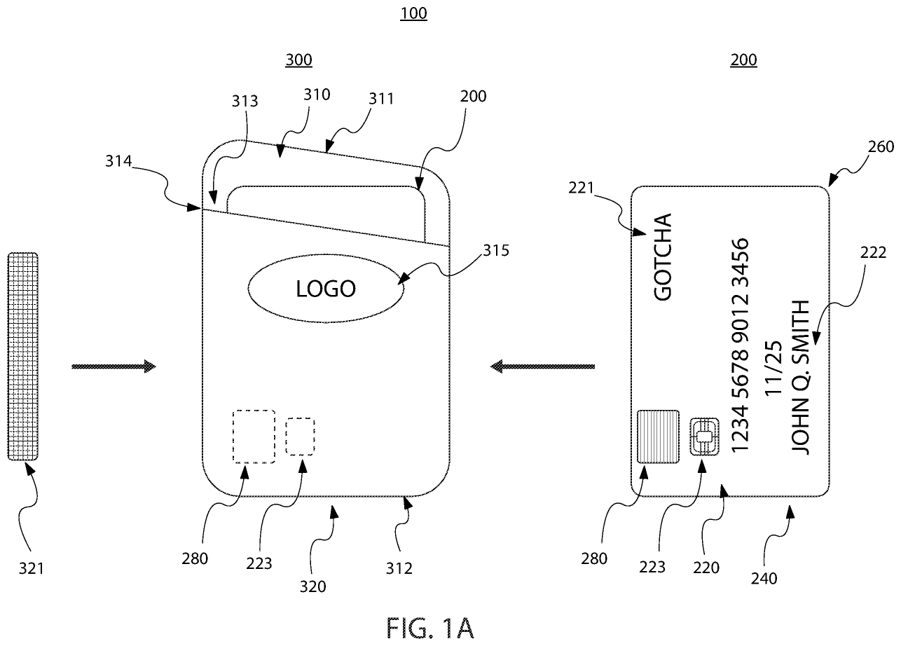

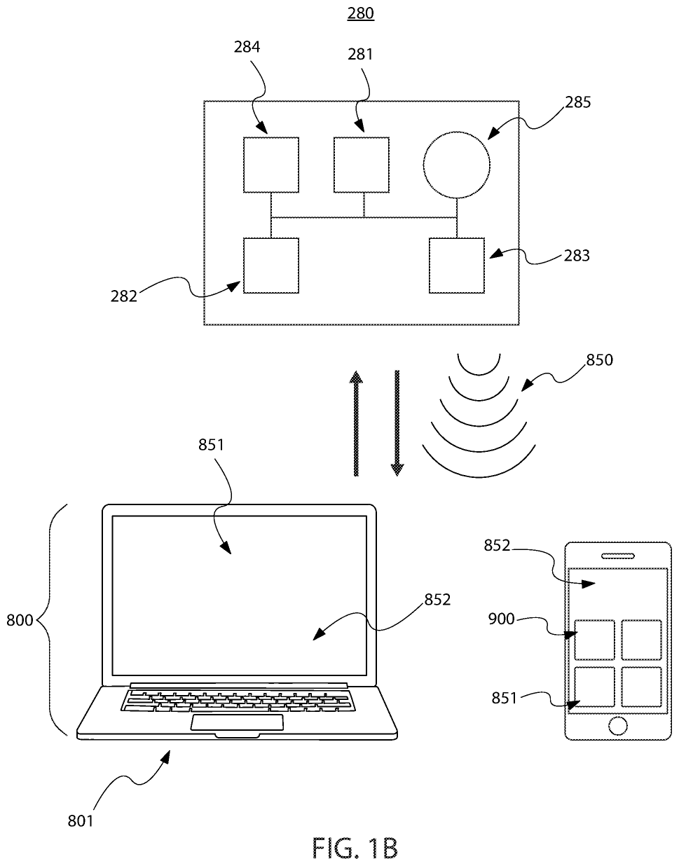

Referring to FIG. 1A and FIG. 1B, an illustrated view of an exemplary banking card locator 100 for locating a lost or stolen banking card is presented. The banking card locator 100 is useful for tracking and finding lost or stolen credit and/or debit cards, individually referred to as a banking card and collectively referred to as banking cards. The banking card locator 100 aids in reducing stress and aggravation of the banking card by alerting a location of the banking card immediately. Further, the banking card locator 100 is useful for preventing unwanted charges and identity theft.

The banking card locator 100 has a banking card 200 and a holder 300. The holder 300 is configured to receive the banking card 200.

The holder 300 has a front 310 and a back 320. The front 310 of the holder 300 has a top 311, a bottom 312 and an interior 313. An opening 314 may be configured to be substantially near the top 311 of the front 310 of the holder 300. The opening 314 provides access to slide or store the banking card 300 in the interior 313 of the holder 300.

Optionally and/or additionally, the back 320 of the holder 300 has a coupling device 321 to securely couple the holder to an item, such as, but not limited to, a cellular phone 900. The coupling device 321 is preferably a Velcro® fastener, however other coupling devices 321 are hereby contemplated, including, but not limited to, a clip, two-sided tape, etc.

Optionally and/or additionally, the front 310 has a logo 315. The logo 315 is preferably a school name, however other logos are hereby contemplated, including, but not limited to, sports logos, names, pictures, etc.

The banking card 200 has a front 220, a back 240 and an interior 260. The banking card 200 is substantially similar to any of the banking cards that are in existence today.

The front 220 of the banking card 200 has a bank name 221, a card holder's name 222, a banking card chip 223 and a locator chip 280. Optionally and/or additionally, the locator chip 280 may be configured to be visible on the front 220 of the banking card 200 or may be non-visible within the interior 260 of the banking card 200. The back 240 of the banking card 200 has a magnetic strip (not shown).

The banking card 200 is preferably a credit/debit card, however other types of banking cards are hereby contemplated, including, but not limited to, a pre-pay credit/debit cards, a department store credit card, where the department store may be any type and kind of retailer, etc.

The magnetic strip is useful when the banking card chip 223 cannot be used for a transaction at a point of sale (POS) card reader (not shown). The banking card chip 223 is configured to be consistent with the use of banking card chips as well known. The banking card chip 223 is configured to be in the interior 260 of the banking card 200 and visible on the front 220 of the banking card 200.

The locator chip 280 is configured to be in the interior 260 of the banking card 200. The locator chip 280 is presented in further detail in FIG. 18. The locator chip 280 is preferably a stand-alone chip, however it is hereby contemplated that the locator chip may be co-located with the bank card chip 223. The locator chip 280 being communicatively coupled to the bank card chip 223.

The locator chip 280 has a computing device 281, a global positioning system (GPS) device 282, a wireless communication device 283, a memory 284 and a power source 285.

The memory 284 may further have stored a personal identification code or passcode, accessible for use of the bank card 200 for purchases, where the personal identification code or passcode may be changed by the user at any time, but the changing of the personal identification code or passcode requires such privacy data to restrict the changing of the personal identification code or passcode only by the holder of the bank card 200, determined by the holder's name and stored access information stored in the memory 284 of the bank card 200.

The power source 285 of the locator chip 280 is preferably a rechargeable battery, however other types of power sources are hereby contemplated, such as, but not limited to, a lithium battery, a disposable battery, etc. Each of the computing device 281, the GPS device 282, the wireless communication device 283 and the memory 284 are electrically coupled to the power source 285. The power source 285 being for providing electrical energy to support the operations of the computing device 281, the GPS device 282, the wireless communication device 283 and the memory 284.

The GPS device 282 is configured to receive GPS location information from GPS satellites or other means for receiving location information of the banking card 200. The GPS device 282 is communicatively coupled to the computing device 281 of the locator chip 280. The computing device 280 receiving the GPS location information is configured to store the received GPS location information in the memory 284 of the locator chip 280.

The wireless communication device 283 of the locator chip 280 is communicatively coupled to the computing device 281 of the locator chip 280. The wireless communications device 283 is configured to send and receive wireless signaling 850 with a remote computing device 800. The remote computing device 800 is preferably a cellular phone 900, however other computing devices are hereby contemplated, including, but not limited to, laptop computer 801, portable personal device, etc.

The wireless signaling 850 is preferably compatible with IEEE 802.11 (WiFi®) standards, however other type of wireless signaling are hereby contemplated, including, but not limited to, 5G® standards, 3GPP®, IEEE 802.15 (Bluetooth®) standards, etc.

An application 851 is configured to be on the remote computing device 800. The application 851 receives information from the locator device 280 and displays on a display 852 of the remote computing device 800 the information for examination by the user of the application 851 on the remote computing device 800 when the application 851 is securely logged into. Further, the application 851, when logged into using a secure login, can be used to request location information and other data, such as, spending information, store used in, etc., which is stored in the memory 284 of the locator device 280.

The computing device 280 stores information received from the GPS device 282 and stores the GPS coordinates (or information) in the memory 284 of the locator device 200. The computing device 280 further receives all activity associated with the banking card 200, such as location the bank card 200 was utilized, amount of purchase, etc.

The computing device 281 stores all information in the memory 284 for later access to the received location information and activity of the bank card 200. When a request from the remote computing device 800 is received and security information is vetted and determined to be an authorized user, the computing device 281 of the locator chip 280 send a message to the wireless communication device 283 to transmit the requested information to the remote computing device 800.

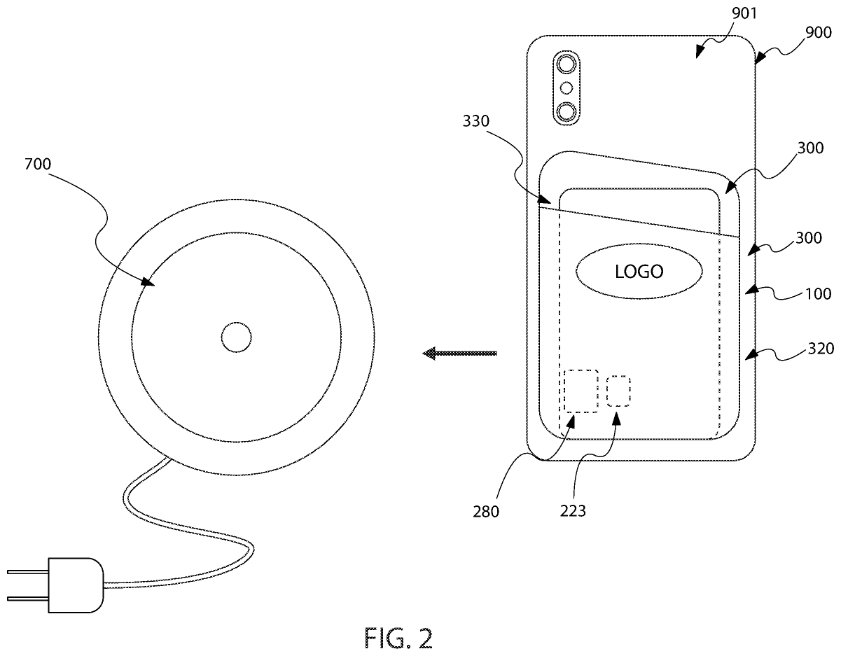

Moving now to FIG. 2, an illustrated view of a use of the banking card locator shown in FIG. 1A is presented.

The back 320 of the holder 300 is securely and removably coupled to a back 901 of a cellular phone 900 by the coupling device 321 (See FIG. 1A). The bank card 200 is securely and removably coupled to the interior 330 of the holder 300. The locator chip 280 of the bank card 200 is configured to align with a positioning of a wireless charging device 700. The holder 300 is placed on the wireless charging device 700 substantially near the locator chip 280 to charge the power source 285 (See FIG. 1B) of the locator chip 280. The charging device 700 is preferably a mobile phone, however other types of charging devices 700 are hereby contemplated, including but not limited to, a wall-plug-in, a solar energy charging station, etc.

The bank card 200 having the locator chip 280 is charged and ready for retrieval of information to locate the bank card 200 when lost or stolen and to retrieve other information requested by the remote computing device 850 (see FIG. 1A).

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Although, the locator chip 280 is preferably co-located on the bank card 200, it is hereby contemplated that a second locator chip 281 is collocated on the mobile phone that is used to charge the phone, when the mobile phone is contemplated as the charging device 700, received GPS location information stored in the locator chip 280 of the bank card 200 until via the wireless communications device 283.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A card locator device for discovering lost or stolen banking cards, the card locator device comprising:
a holder, the holder having a front, a back, a top, a bottom and an interior, wherein the top of the holder having an opening configured to access the interior of the holder;
a banking card, the banking card comprising:
a front;
a back;
an interior;
a banking chip, the bank card chip being configured to be in the interior of the banking card;
a locator chip, the locator chip comprising:
a power source;
a wireless communications device, the wireless communication device being electrically coupled to the power source;
a memory, the memory being electrically coupled to the power source;
a global position system (GPS) device, the GPS device being electrically coupled to the power source; and
a computing device, the computing device being electrically coupled to the power source, the computing chip being communicatively coupled to the bank card chip, the GPS device, the wireless communications device and the memory.

2. The card locator device of claim 1, wherein the holder further comprising a logo, the logo being coupled to the front of the holder.

3. The card locator device of claim 2, wherein the logo being a school logo.

4. The card locator device of claim 1, wherein the back of the holder further comprising a coupling device.

5. The card locator device of claim 4, wherein the coupling device being a Velcro® fastener.

6. The card locator device of claim 1, wherein the computing device being communicatively coupled to a remote computing device by a wireless signal, wherein the wireless signal being sent and received by the wireless communications device.

7. The card locator device of claim 1, wherein computing device being configured to receive GPS information from the GPS chip.

8. The card locator device of claim 7, wherein the computing device being configured to store the received GPS information.

9. The card locator device of claim 1, wherein the computing device being configured to store banking information at the memory.

10. The card locator device of claim 1, wherein the computing chip receiving security information from a remote computing device, and wherein the computing device authenticating the security information.

11. The card locator device of claim 1, wherein the card locator device further comprising a wireless charging device.

12. The card locator device of claim 11, wherein the power source being charged by the wireless charging device.

13. The card locator device of claim 1, wherein the GPS information being displayed at the remote computing device.

14. The card locator device of claim 1, wherein the banking information being displayed at the remote computing device.

15. The card locator device of claim 1, wherein the wireless signaling by the wireless communications device being compatible with IEEE 802.11 (WiFi®) standards.

16. The card locator device of claim 1, wherein the banking card being securely and removably coupled to the interior of the holder.
